(19) United States
(12) Patent Application Publication
(10) Pub. No.: US 2026/0229533 A1
(43) Pub. Date: Aug. 6, 2026

(54) CURRENT COLLECTOR-LESS ELECTRODES FOR ENERGY STORAGE OR ELECTRON TRANSPORT DEVICES

(71) Applicant: MATERIAL HYBRID MANUFACTURING, INC., Miami, FL (US)

(72) Inventors: Christopher Reyes, San Marcos, TX (US); Gabriel Elias, Miami Beach, FL (US); Miles Dotson, Oakland, CA (US); Antonio Nicolas Briceno, Miami, FL (US)

(21) Appl. No.: 19/530,269

(22) Filed: Feb. 4, 2026

Related U.S. Application Data
(60) Provisional application No. 63/753,697, filed on Feb. 4, 2025.

(51) Int. Cl. H01M 4/62; H01M 4/04; H01M 4/38; H01M 4/505; H01M 4/525; H01M 4/58; H01M 4/583; H01M 10/0525; H01M 4/02

(52) U.S. Cl. CPC H01M 4/625; H01M 4/0471; H01M 4/381; H01M 4/386; H01M 4/505; H01M 4/525; H01M 4/5825; H01M 4/583; H01M 10/0525; H01M 2004/021

(57) ABSTRACT

An energy storage or electron transfer device that lacks a current collector is formed by depositing a network of conductive nanomaterials in an electrode medium to form a continuous, self-supporting mesh embedded in the electrode medium. Junctions of the deposited network of conductive nanomaterials are nanowelded to reduce junction resistance and increase mechanical cohesion. An application-specific process is performed on the welded network of conductive nanomaterials to satisfy one or more requirements for a specific application. Examples of the one or more requirements include a particular morphology, composition, or interfaces, where the application-specific process can include controlling porosity or pore size distribution, selecting or adding surface coatings, or allocating mass or thickness to maintain conductivity and performance with a target nanonetwork.

### CROSS-REFERENCE TO RELATED APPLICATIONS

This application claims priority to and benefit from U.S. Provisional Patent Application No. 63/753,697, entitled “Current Collector-less Electrodes for Energy Storage and Electron Transport Devices,” filed on February 4, 2025, which is hereby incorporated by reference in its entirety.

### BACKGROUND

An electric battery is a source of electric power including one or more electrochemical cells with external connections for powering electrical devices. When a battery is supplying power, its positive electrode is the cathode and its negative electrode is the anode. The electrode marked negative is the source of electrons. When a battery is connected to an external electric load, those negatively charged electrons flow through the circuit and reach the positive electrode, thus causing a redox reaction by attracting positively charged ions, or cations. Thus, higher energy reactants are converted to lower energy products, and the free-energy difference is delivered to the external circuit as electrical energy.

### BRIEF DESCRIPTION OF THE DRAWINGS

Reference will now be made, by way of example, to the accompanying drawings which show example embodiments of the present application, and in which:

FIG. 1 illustrates a manufacturing process for producing a self-supporting, nanowelded conductive network for use as a collector-less electrode.

FIG. 2 illustrates a graphical comparison of structures and functions between conventional electrodes and nanomaterial-based electrodes.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure pertains to electrodes of energy storage and electron transport devices. Specifically, it describes self-supporting, nanomaterial-based electrodes that eliminate the need for traditional current collectors, leading to improved efficiency, reduced weight, and enhanced scalability in applications such as batteries, supercapacitors, piezoelectric, thermoelectric, and catalytic systems.

Current collectors are crucial for electrical conduction in energy storage devices, yet they introduce several challenges, including mass and volume constraints. For example, current collectors account for 10-20% of total device mass in lithium-ion batteries, reducing energy density. Another challenge includes design limitations because the rigidity and conductive requirements of copper and aluminum foils restrict flexible or non-planar designs. Yet another challenge includes manufacturing complexity. In particular, the need for conductive foils, along with additional processing steps, increases cost and production time. To address these problems, the disclosed technology proposes a nanomaterial-based conduction network that removes the necessity of metal foils, creating a lightweight, flexible, and high-performance solution.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Nanomaterial-Based Electrodes

The disclosed technology provides a self-supporting conductive network, eliminating traditional current collectors and conductive additives found in conventional electrodes of energy storage and electron transfer devices. The technology enables greater efficiency, simplified manufacturing, and expanded application possibilities.

A current collector is a conductive substrate having a given geometry and being configured to receive and transmit electrons between an electrode’s active material and an external circuit. The given geometry has a uniform volume with a mass and a weight. During discharge, the current collector gathers electrons generated by electrochemical reactions occurring within the electrode coating and conducts them out of the cell; during charge, it supplies electrons to the electrode to drive the reverse reactions. The current collector is substantially inert with respect to the cell’s electrochemical processes and does not itself participate in the redox reactions. Its primary functions are to provide a low-resistance electrical pathway, promote uniform current distribution across the electrode area, and furnish mechanical support for the active material layer and associated binders and conductive additives.

In some examples, a current collector includes a thin metallic foil, mesh, or coated substrate. In lithium-ion cells, the positive electrode (cathode) coating is commonly applied to an aluminum current collector, selected for corrosion resistance and stability at higher potentials, while the negative electrode (anode) coating is commonly applied to a copper current collector, selected for conductivity and stability at lower potentials. Alternative materials (e.g., stainless steel, nickel, or graphite-based collectors) may be employed in other chemistries, subject to electrolyte compatibility and electrode potential. The collector surface may be textured, roughened, or treated (for example, with carbon coatings or oxide management processes) to improve adhesion to the electrode slurry and to reduce interfacial contact resistance.

Design parameters of the current collector include thickness, purity, and mechanical properties, which collectively balance electrical conductivity, weight, cost, and manufacturability. A current collector is configured to maintain integrity through electrode fabrication steps such as coating, drying, calendering, and subsequent cell assembly operations including winding or stacking.

In embodiments of the disclosed technology, the current collectors are entirely removed thereby eliminating copper or aluminum foils, reducing device mass by up to 20% or more. This enhances energy density and functional efficiency. Embodiments of the disclosed technology include a nanomaterial-based conduction network that forms a self-supporting mesh with high conductivity. This structure provides mechanical integrity without additional reinforcement. Applications of the disclosed technology are versatile, including batteries and supercapacitors, piezoelectric/thermoelectric devices, and catalyst reactors, for example. Manufacturing advantages of the disclosed technology include the elimination of conductive additives like carbon black, such that production is simplified and material utilization is improved.

Nanomaterial-based conduction, as used herein, can refer to electron transport through a self-supporting network of conductive nanomaterials that replaces traditional metal current collectors and carbon-based conductive additives. Examples of nanomaterials include nanowires, nanotubes, graphene flakes, and other nanoscale conductors. The network is deposited to form a continuous, percolating mesh within the electrode structure or as the electrode body itself. Junctions between individual nanoscale elements are joined via nanowelding, which locally fuses contacts at the nanoscale to create low-resistance pathways across the entire electrode.

In certain embodiments, the nanomaterial network provides both electrical conductivity and mechanical integrity, enabling operation without copper or aluminum foils and without added conductive fillers such as carbon black. The mesh interpenetrates or interconnects the active material, establishing direct electron pathways through the nanomaterial framework and into the active particles. By minimizing contact resistance at nanoscale junctions and ensuring robust continuity, the network facilitates efficient electron percolation throughout the electrode volume.

This construction yields collector-less electrodes with reduced mass and improved energy density, as removal of current collector foils can eliminate up to 10–20% or more of device mass depending on application. Lower resistive losses can increase power potential and functional efficiency, while the self-supporting, porous architecture supports flexible or non-planar geometries. Further, manufacturing can be simplified by omitting conductive additives and associated processing steps, improving material utilization and scalability for batteries, supercapacitors, piezoelectric and thermoelectric devices, and catalytic systems.

As used herein, nanowelding can refer to joining materials at dimensions of approximately 1–100 nanometers to form mechanically robust and electrically conductive interfaces among nanostructures. In various embodiments, localized energy is delivered to a junction to induce melting, diffusion, or direct atomic bonding. Examples include thermal nanowelding using focused heat sources (e.g., lasers, nanoheaters, or electron beams), electron or ion beam welding in microscopy environments to drive atom migration at targeted sites, and plasmonic or photonic welding in which optical excitation generates nanoscale “hot spots” that fuse adjacent particles. Additional embodiments employ chemical approaches (e.g., nanobrazing or nanosoldering) that utilize reactive or low-melting formulations to create joints through capillary action and interfacial reactions at reduced temperatures, mechanical or pressure-assisted welding that promotes atomic diffusion under applied force from a nanoscale manipulator, and cold welding wherein ultra-clean, oxide-free surfaces bond upon contact due to high surface energies and strong interfacial forces.

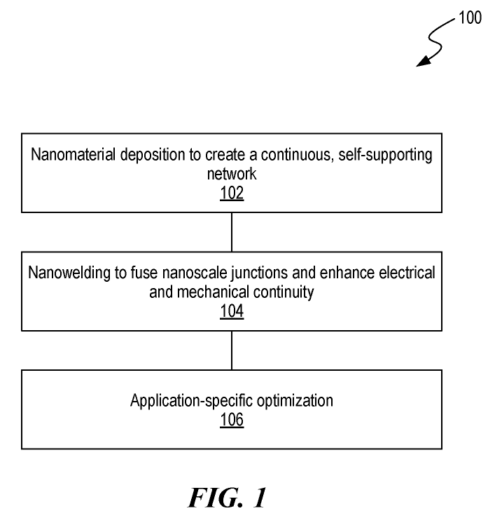

FIG. 1 illustrates a manufacturing process 100 for producing a self-supporting, nanowelded conductive network suitable for use as a collector-less electrode. The process 100 includes: (i) nanomaterial deposition (102) to create a continuous, self-supporting network; (ii) nanowelding (104) to fuse nanoscale junctions and enhance electrical and mechanical continuity; and (iii) application-specific optimization (106) to tailor porosity, composition, and surface properties for target devices such as batteries, supercapacitors, thermoelectric and piezoelectric systems, and catalytic reactors.

At 102 (nanomaterial deposition), a continuous, network of conductive nanomaterials is formed to provide long-range electron transport without a metal foil current collector. Suitable feedstocks include, for example, (a) metallic nanowires such as silver, copper, nickel, or gold nanowires with mean diameters of approximately 20–200 nm and aspect ratios greater than 200 to promote low percolation thresholds; (b) carbon nanostructures such as single-walled or multi-walled carbon nanotubes (CNTs), graphene flakes, reduced graphene oxide, and carbon nanofibers, alone or in hybrid mixtures (e.g., CNT–graphene blends) to balance conductivity, toughness, and flexibility; and (c) composite networks, including co-dispersed metal nanowires with CNTs or graphene for improved contact quality and redundancy, and ceramic-coated nanowires (e.g., thin oxide shells) for stability in harsh chemistries with optional selective shell thinning or removal at junctions.

Deposition can be achieved by one or more of the following, as examples: (a) vacuum filtration casting, wherein a well-dispersed aqueous or alcoholic ink of CNTs and/or nanowires is filtered through a membrane to form a uniform mat that is dried and released to yield a free-standing conductive film with controlled areal density; (b) spray or slot-die coating onto a substrate, wherein layer-by-layer deposition builds thickness while maintaining porosity, followed by drying and lift-off by dissolving or mechanically separating the layer to generate a self-supporting mesh; (c) electrophoretic deposition (EPD), wherein charged nanomaterials are driven to a collecting surface under an electric field to form conformal, thickness-controlled networks on planar or non-planar forms, with optional delamination to provide a free-standing scaffold or retention as a conformal coating for three-dimensional architectures; and (d) aerogel or cryogel formation, wherein freeze-casting or supercritical drying produces ultralight, highly porous networks that can be subsequently densified (e.g., by mild compression or calendering) to tune conductivity and mechanical robustness.

Examples of structural targets and control parameters at 102 can include: (a) percolation density set above the percolation threshold to minimize mass while ensuring continuous pathways, for example achieving sheet resistances in the range of approximately 0.1–10 Ω/sq for thin films or bulk resistivities comparable to carbon paper for thicker scaffolds; (b) porosity and pore size tailored to an application, such as macroporosity with approximately 1–50 µm pores to facilitate ion transport and electrolyte wetting in electrochemical systems while retaining nanoporosity to increase surface area for catalytic and thermoelectric interfaces; and (c) mechanical integrity sufficient to enable free-standing handling through downstream processing (e.g., lamination, winding, stacking) without tearing, which can be achieved by hybridization (e.g., CNTs for toughness, nanowires for conductivity) and graded architectures (e.g., denser skin, more porous core).

Illustrative examples at 102 include: (a) a battery anode scaffold formed by vacuum-filtering a CNT/graphene slurry (approximately 70/30 mass ratio) in water with a mild surfactant to yield a 20–40 µm-thick mat; after surfactant removal by solvent exchange and drying, the mat exhibits approximately 1–3 Ω/sq sheet resistance and greater than 40% porosity, suitable for hosting silicon or graphite active particles without a copper foil; and (b) a conformal three-dimensional coating formed by EPD of copper nanowires onto a porous ceramic tube to create a continuous, conductive skin for a catalytic reactor, wherein the skin remains after tube removal or serves as a permanent support.

At 104 (nanowelding of the conductive network), junction resistance is reduced and mechanical cohesion is increased by fusing low-impedance contacts between intersecting nanomaterials, thereby transforming a loosely percolated mesh into a continuous, robust conductor. Representative nanowelding modalities include, by way of example: (a) photonic or thermal pulse welding, such as intense pulsed light (IPL) or rapid thermal annealing, which produces transient temperature rises localized at junctions (where absorption is highest) to sinter metallic nanowire contacts without collapsing macro-porosity; (b) plasmonic welding for metal–metal junctions, wherein selective wavelength illumination excites plasmonic hot spots at overlaps of silver or copper nanowires to promote local fusion with minimal global heating; (c) chemical nanobrazing or nanosoldering, wherein low-melting metallic precursors (e.g., silver salt inks or Bi–Sn nanosolders) wick to junctions by capillarity and form metallurgical bonds upon gentle heating, which is useful for heterogeneous networks (e.g., metal–carbon, metal–oxide); and (d) cold welding or pressure-assisted bonding, wherein under clean-surface conditions, moderate pressure (e.g., roll pressing or point-force application) promotes atomic diffusion and plastic deformation at contacts to increase true contact area and reduce resistance.

Example outcome metrics for 104 can include: (a) junction resistance reductions of approximately 5X to 50X compared to as-deposited meshes, measured by four-point probe or transmission line method (TLM) structures; (b) mechanical robustness improvements of at least approximately 2X in tensile strength or fold endurance for free-standing films, enabling winding or flexing without fracture; and (c) stability evidenced by sustained conductivity after at least approximately 1,000 bending cycles for flexible formats or after calendering to specified densification levels for battery electrodes.

At 106 (application-specific optimization), the welded network’s morphology, composition, and/or interfaces are tailored to the requirements of specific devices while preserving the collector-less, self-supporting function. For batteries (including lithium-ion, sodium-ion, and solid-state), examples include: (a) integrating active materials by infiltrating the welded scaffold with slurry or dry powders (e.g., LFP, NMC, silicon, graphite, sulfur host) such that active particles interpenetrate the network, with optional mild post-calendering to ensure particle–network contact; (b) maintaining approximately 30–60% open porosity and selecting a pore size distribution that balances electrolyte wetting and tortuosity, optionally introducing vertical macropore channels for thick electrodes (e.g., greater than 200 µm); (c) engineering interfaces with ultrathin carbon or conductive polymer skins to reduce charge-transfer resistance, and for solid-state systems, conformally coating with ion-conductive layers (e.g., sulfide or polymer electrolytes) to ensure percolating ion/electron bicontinuity; and (d) budgeting mass and thickness such that the removal of 10–20% current collector mass is replaced with not more than approximately 3–5% nanonetwork mass while maintaining areal capacities typical of the chemistry, with internal resistance benchmarked via rate capability and pulse power tests.

For supercapacitors, examples of optimization include: (a) increasing accessible surface area via hierarchical porosity; (b) incorporating pseudocapacitive species (e.g., MnO₂ or conducting polymers) grown onto the welded scaffold; and (c) minimizing equivalent series resistance by emphasizing junction welding and redundant conductive pathways for high-power operation.

For thermoelectric and piezoelectric devices, examples include: (a) balancing thermal and electrical transport by preserving electrical continuity while limiting parasitic thermal conduction through introduction of discontinuous metallic pathways interlaced with low-thermal-conductivity carbon domains in thermoelectric applications; and (b) employing thin, highly flexible welded meshes that maintain conductivity under cyclic strain in piezoelectric harvesters on curved substrates.

For catalytic systems and reactors, examples include: (a) maintaining open macroporous channels to facilitate reactant exposure and mass transport; (b) distributing catalytic nanoparticles (e.g., Pt, Ni, or Co-based) on the welded network to improve utilization; and (c) selecting metals and post-treatments compatible with operating media, such as applying protective graphene skins on copper in aqueous or alkaline environments to improve corrosion resistance.

Quality control and metrology for process 100 can include: (a) electrical continuity mapping using conductive atomic force microscopy, eddy-current mapping, or four-point arrays to confirm uniform, low-resistance coverage; (b) morphology verification by scanning or transmission electron microscopy to confirm welded necks, and surface area and pore distribution measurements (e.g., BET and/or mercury porosimetry), as well as mechanical testing (e.g., tensile strength and minimum bend radius) to confirm handling robustness; and (c) defining process windows with acceptable bands for sheet resistance, porosity, thickness, and weld energy dose to ensure reproducibility at scale.

An illustrative end-to-end example of process 100 for a collector-less lithium-ion cathode includes: (a) depositing a CNT/silver-nanowire network of approximately 15 µm thickness by spray-coating onto a dissolvable polymer film, followed by drying and lift-off to obtain a free-standing scaffold; (b) nanowelding by applying two photonic pulses in nitrogen to fuse Ag–Ag and Ag–CNT junctions, achieving approximately 0.8 Ω/sq sheet resistance and greater than 35% porosity; (c) integrating active material by impregnating with NMC811 slurry (without carbon black) to approximately 60–70% active material by volume, followed by mild calendering to align particles with the conductive skeleton; and (d) assembling the electrode into a pouch cell stack without an aluminum foil current collector, yielding comparable areal capacity with improved gravimetric energy due to elimination of the foil and conductive additive.

Sequencing variations within process 100 include, for example: (a) performing nanowelding at step 104 prior to active material loading in step 106 to protect heat-sensitive chemistries; (b) performing selective, low-temperature welding after active material loading to improve final contact quality; and (c) executing deposition at step 102 directly onto the final device form for three-dimensional or flexible formats to minimize handling, followed by in-place nanowelding and application-specific optimization. Process 100 thus encompasses constructing a percolating, self-supporting nanomaterial mesh with controlled porosity and mechanical strength, nanowelding to reduce junction resistance and increase cohesion while preserving architecture, and tailoring the welded network’s structure and interfaces to the operational demands of specific energy storage, conversion, and catalytic applications.

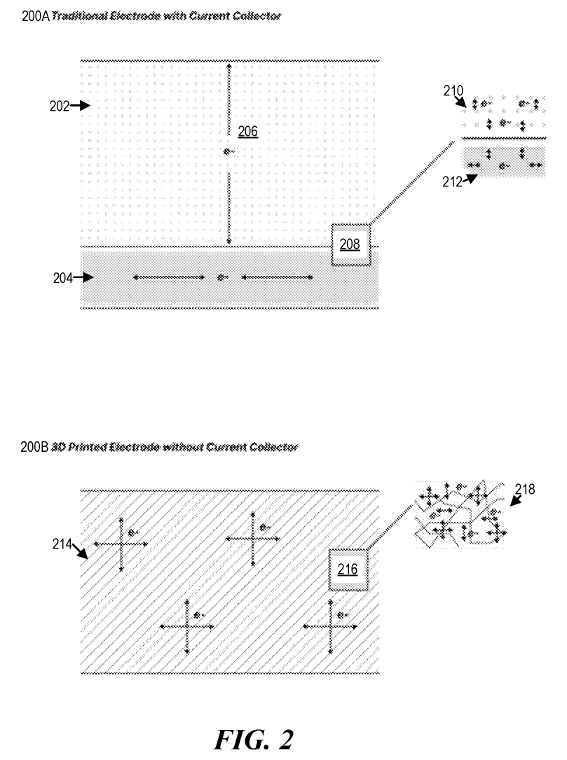

FIG. 2 illustrates a graphical comparison of structures and function between conventional electrodes and nanomaterial-based electrodes. The traditional electrode with current collector 200A includes an electrode medium 202, metal current collector 204, and has an electron flow in medium 206 and electron flow in current collector 208. Further, 210 shows a zoomed-in detail of electron flow in conductive additive 202 while 212 shows a zoomed-in detail of electron flow within the current collector 204. As shown, the electron flow in medium 206 is perpendicular to the electron flow in current collector 208. In contrast, the 3D printed electrode without a current collector 200B includes a composite electrode 214, and an electron flow in composite electrode 216. Further, 212 shows a zoomed-in detail electron flow in nanomaterial within an electrode. In contrast to the traditional electrode with current collector 200A, the electron flow in the composite electrode 214 is oriented in various directions, that are not uniform. For example, the electron flow can be in numerous or random orientations and directions throughout the composite electrode.

### Examples

In some examples, the techniques described herein relate to a method of manufacturing an electrode for an energy storage or electron transfer device that lacks a current collector. The method includes depositing a network of conductive nanomaterials in an electrode medium to form a continuous, self-supporting mesh embedded in the electrode medium, nanowelding junctions of the deposited network of conductive nanomaterials to reduce junction resistance and increase mechanical cohesion of the deposited network of conductive nanomaterials in the electrode medium, and perform an application-specific process on the welded network of conductive nanomaterials to satisfy one or more requirements for a specific application. The one or more requirements can include a particular morphology, composition, or interfaces, wherein the application-specific process including controlling porosity or pore size distribution, selecting or adding surface coatings, or allocating mass or thickness to maintain conductivity and performance with a target nanonetwork.

In some examples, the conductive nanomaterials include one or more of: carbon nanotubes, graphene, carbon nanofibers, metal nanowires including silver or copper, or a conductive polymer.

In some examples, the nanowelding includes photonic sintering, thermal annealing, Joule heating, plasma treatment, or chemical sintering, where the nanowelding reduces inter-nanomaterial junction resistance by at least 20% relative to the as-deposited network.

In some examples, the continuous, self-supporting mesh has a porosity between 20% and 80% and a mean pore size between 0.1 μm and 10 μm after performing the application-specific process.

In some examples, the application-specific process includes applying a surface coating selected from metal, metal oxide, carbon, or conductive polymer coatings to tailor interfacial properties with an active material or electrolyte of the energy storage or electron transfer device.

In some examples, the nanowelding increases mechanical cohesion such that the self-supporting mesh exhibits a tensile strength of at least 5 MPa.

In some examples, the method further includes integrating an electrochemically active material into or onto the welded network of conductive nanomaterials by infiltration, co-deposition, electrophoretic deposition, vapor deposition, or slurry casting to form the electrode that remains free of the current collector. In some examples, the the electrochemically active material includes one or more of graphite, silicon or silicon-carbon composite, lithium iron phosphate, lithium nickel manganese cobalt oxide, sulfur, or a sodium-ion active material.

In some examples, controlling pore size distribution includes forming a gradient porosity across the mesh thickness to facilitate ion transport while maintaining electronic conductivity through the plane of the mesh.

In some examples, the energy storage or electron transfer device is a lithium-ion battery, sodium-ion battery, or supercapacitor having a greater gravimetric energy density compared to a geometrically comparable device incorporating a current collector.

In some examples, the techniques described herein relate to a method of manufacturing an energy storage or electron transfer device that lacks a current collector. The method includes depositing a network of conductive nanomaterials in an electrode medium, nanowelding the deposited network of conductive nanomaterials in the electrode medium, and processing the welded network of conductive nanomaterials to satisfy a requirement for an application. Examples of the processing includes controlling porosity, selecting or adding surface coatings, or allocating mass to maintain conductivity and performance with a target nanonetwork.

In some examples, the conductive nanomaterials include one or more of carbon particles, metal nanowires, or conductive polymers.

In some examples, the nanowelding reduces inter-nanomaterial junction resistance compared to the as-deposited network.

In some examples, processing the welded network of conductive nanomaterials includes applying a surface coating configured to tailor interfacial properties with an active material or electrolyte.

In some examples, the method further includes integrating an electrochemically active material into or onto the welded network to form an electrode that remains free of a current collector.

In some examples, controlling pore size distribution includes forming a gradient porosity across a mesh thickness to facilitate ion transport while maintaining electronic conductivity through a plane of the mesh.

In some examples, the energy storage or electron transfer device is a lithium-ion battery, sodium-ion battery, or supercapacitor having a greater energy density compared to a volumetrically comparable energy storage or electron transfer device incorporating a current collector.

In some examples, an electrode of an energy storage or electron transfer device includes an electrode medium and a network of conductive nanomaterials with nanowelded junctions to form a continuous, self-supporting mesh in the electrode medium that lacks a current conductor. The electrode has a morphology, composition, or interfaces configured for a specific application.

In some examples, the deposited network of conductive nanomaterials is nanowelded to reduce junction resistance and increase mechanical cohesion of the deposited network of conductive nanomaterials in the electrode medium.

In some examples, the electrode includes a surface coating selected from metal, metal oxide, carbon, or conductive polymer coatings to tailor interfacial properties with an active material or electrolyte.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method of manufacturing an electrode for an energy storage or electron transfer device that lacks a current collector, the method comprising:
depositing a network of conductive nanomaterials in an electrode medium to form a continuous, self-supporting mesh embedded in the electrode medium;
nanowelding junctions of the deposited network of conductive nanomaterials to reduce junction resistance and increase mechanical cohesion of the deposited network of conductive nanomaterials in the electrode medium; and
perform an application-specific process on the welded network of conductive nanomaterials to satisfy one or more requirements for a specific application, the one or more requirements including a morphology, composition, or interfaces,
wherein the application-specific process comprising controlling porosity or pore size distribution, selecting or adding surface coatings, or allocating mass or thickness to maintain conductivity and performance with a target nanonetwork.

2. The method of claim 1, wherein the conductive nanomaterials comprise one or more of:
carbon nanotubes,
graphene,
carbon nanofibers,
metal nanowires comprising silver or copper, or
a conductive polymer.

3. The method of claim 1, wherein the nanowelding comprises:
photonic sintering,
thermal annealing,
Joule heating,
plasma treatment, or
chemical sintering,
wherein the nanowelding reduces inter-nanomaterial junction resistance by at least 20% relative to the as-deposited network.

4. The method of claim 1, wherein the continuous, self-supporting mesh has a porosity between 20% and 80% and a mean pore size between 0.1 μm and 10 μm after performing the application-specific process.

5. The method of claim 1, wherein the application-specific process comprises:
applying a surface coating selected from metal, metal oxide, carbon, or conductive polymer coatings to tailor interfacial properties with an active material or electrolyte of the energy storage or electron transfer device.

6. The method of claim 1, wherein the nanowelding increases mechanical cohesion such that the self-supporting mesh exhibits a tensile strength of at least 5 MPa.

7. The method of claim 1, further comprising:
integrating an electrochemically active material into or onto the welded network of conductive nanomaterials by infiltration, co-deposition, electrophoretic deposition, vapor deposition, or slurry casting to form the electrode that remains free of the current collector.

8. The method of claim 7, wherein the electrochemically active material comprises one or more of graphite, silicon or silicon–carbon composite, lithium iron phosphate, lithium nickel manganese cobalt oxide, sulfur, or a sodium-ion active material.

9. The method of claim 1, wherein controlling pore size distribution comprises:
forming a gradient porosity across the mesh thickness to facilitate ion transport while maintaining electronic conductivity through a plane of the mesh.

10. The method of claim 1, wherein the energy storage or electron transfer device is a lithium-ion battery, sodium-ion battery, or supercapacitor having a greater gravimetric energy density compared to a geometrically comparable device incorporating a current collector.

11. A method of manufacturing an energy storage or electron transfer device that lacks a current collector, the method comprising:
depositing a network of conductive nanomaterials in an electrode medium;
nanowelding the deposited network of conductive nanomaterials in the electrode medium; and
processing the welded network of conductive nanomaterials to satisfy a requirement for an application,
wherein the processing comprises controlling porosity, selecting or adding surface coatings, or allocating mass to maintain conductivity and performance with a target nanonetwork.

12. The method of claim 11, wherein the conductive nanomaterials comprise one or more of:
carbon particles,
metal nanowires, or
conductive polymers.

13. The method of claim 11, wherein the nanowelding reduces inter-nanomaterial junction resistance compared to the as-deposited network.

14. The method of claim 11, wherein processing the welded network of conductive nanomaterials comprises:
applying a surface coating configured to tailor interfacial properties with an active material or electrolyte.

15. The method of claim 11, further comprising:
integrating an electrochemically active material into or onto the welded network to form an electrode that remains free of a current collector.

16. The method of claim 11, wherein controlling pore size distribution comprises
forming a gradient porosity across a mesh thickness to facilitate ion transport while maintaining electronic conductivity through a plane of the mesh.

17. The method of claim 11, wherein the energy storage or electron transfer device is a lithium-ion battery, sodium-ion battery, or supercapacitor having a greater energy density compared to a volumetrically comparable energy storage or electron transfer device incorporating a current collector.

18. An electrode of an energy storage or electron transfer device comprising:
an electrode medium; and
a deposited network of conductive nanomaterials with nanowelded junctions to form a continuous, self-supporting mesh in the electrode medium that lacks a current conductor; and
a morphology, composition, or interfaces configured for a specific application.

19. The electrode of claim 18, wherein the deposited network of conductive nanomaterials is nanowelded to reduce junction resistance and increase mechanical cohesion of the deposited network of conductive nanomaterials in the electrode medium.

20. The electrode of claim 18 comprising:
a surface coating selected from metal, metal oxide, carbon, or conductive polymer coatings to tailor interfacial properties with an active material or electrolyte.
